(19) United States
(12) Patent Application Publication
(10) Pub. No.: US 2002/0049669 A1
(43) Pub. Date: Apr. 25, 2002

(54) Method of selling giftcards

(76) Inventors: Michael Bleser, Deerfield, IL (US); Allan M. Resnick, Northbrook, IL (US); Laura Merten, Deerfield, IL (US); John William Gleeson II, Chicago, IL (US)

Correspondence Address: MARSHALL, O'TOOLE, GERSTEIN, MURRAY & BORUN, 6300 SEARS TOWER, 233 SOUTH WACKER DRIVE, CHICAGO, IL, 60606-6402, US

(21) Appl. No.: 09/852,501

(22) Filed: May 10, 2001

Related U.S. Application Data
(60) Provisional application No. 60/203,490, filed on May 10, 2000.
(60) Provisional application No. 60/203,834, filed on May 12, 2000.

(51) Int. Cl. G06F 17/60

(52) U.S. Cl. 705/39; 705/27

(57) ABSTRACT

A method for selling a giftcard at a store location of a first retailer for use at a second retailer is disclosed. The method comprises displaying giftcards in the store location of the first retailer. A giftcard is activated upon receipt of a purchase amount from a customer, and active giftcard information is forwarded to a processor associated with the second retailer. Proceeds from the first retailer are then transferred to the second retailer, the proceeds including at least a portion of the purchase amount. A method of selling a multi-store giftcard, which is usable at a plurality of second retailers, is also disclosed.

### CROSS-REFERENCE TO RELATED APPLICATION

This application claims the benefit under 35 U.S.C. § 119(e) of U.S. provisional patent application Serial No. 60/203,490 filed May 10, 2000, and U.S. provisional patent application Serial No. 60/203,834, the disclosures of which are incorporated herein by reference.

### FIELD OF THE INVENTION

The invention generally relates to methods of transacting retail sales and, more particularly, to methods of selling gift certificate cards.

### BACKGROUND OF THE INVENTION

Gift certificate cards, or giftcards, have recently gained in popularity as an alternative to traditional paper gift certificates. Giftcards are typically provided in a form similar to that of credit cards. Accordingly, a typical giftcard includes a rectangular plastic body having a strip for magnetically storing information. The giftcard is redeemable for merchandise or services provided by the retailer that issued the giftcard.

Giftcards are typically in an inactive state until purchased. When the giftcard is purchased, it is typically swiped through a card reader which reads the information stored on the giftcard and forwards the information to the retailer's computer center. The computer center, in turn, forwards information to a giftcard processor, which maybe provided by the retailer or, more typically, an outside party, thereby activating the giftcard. The giftcard may then be used at a store of the retailer.

Giftcards of a particular retailer are typically sold only inside a store location of that retailer. As a result, a customer desiring to purchase a giftcard of an outside retailer must go to a store location of that retailer, thereby inconveniencing the customer. In addition, customers may want to purchase giftcards usable at several locations. Currently, the customer must travel to a store location of each retailer to purchase a giftcard usable at that location.

Gift certificate kiosks are known for generating gift certificates for one or more remote or off-site retailers. Veeneman et al., U.S. Pat. No. 5,243,174, for example, discloses a method and apparatus for generating gift certificates in which a dispensing device, such as a kiosk, is provided. The consumer inserts a credit card into the device and uses a touchscreen to select a retailer from a menu ofparticipating retailers and enters a value for the gift certificate. The dispensing device verifies the credit card, debits the appropriate account, and prints a gift certificate.

The dispensing device of Veeneman et al. is overly difficult and cumbersome to use. The consumer must be comfortable with using touchscreens, and must respond to a series of queries in order to select a retailer and the desired amount for the gift certificate. Furthermore, marketing of the gift certificates is limited to the appearance of the kiosk and artwork or graphics shown thereon, and the gift certificate is not viewable until purchased and dispensed.

### SUMMARY OF THE INVENTION

In accordance with certain aspects of the invention, a method is provided for selling a giftcard at a store location of a first retailer for use at a second retailer. The method comprises displaying giftcards in the store location of the first retailer, activating a giftcard upon receipt of a purchase amount from a customer, and forwarding active giftcard information to a processor associated with the second retailer. Proceeds are transferred from the first retailer to the second retailer, the proceeds including at least a portion of the purchase amount.

In accordance with additional aspects of the invention, a method is provided for selling a giftcard at a store location of a first retailer for use at a plurality of second retailers. The method comprises displaying giftcards in the store location of the first retailer, activating a giftcard upon receipt of a purchase amount from a customer, and forwarding active giftcard information to a processor associated with the plurality of second retailers. Proceeds are transferred from the first retailer to the plurality of second retailers, the proceeds including at least a portion of the purchase amount.

Other features and advantages are inherent in the disclosed apparatus or will become apparent to those of ordinary skill in the art from the following detailed description and its accompanying drawings.

### BRIEF DESCRIPTION OF THE DRAWINGS

FIG. 1 is a flow chart of the steps followed during a gift card sale, in accordance with the teachings of the present invention.

### DETAILED DESCRIPTION OF THE PREFERRED EMBODIMENT

One method according to the present invention generally relates to the sale of a giftcard at a store location of a first retailer, which is usable at a second or outside retailer. As used herein, the term “giftcard” is intended to include all types of portable storage devices, such as cards, certificates and other documents capable of storing or denoting a credit value. This definition includes conventional credit card style giftcards, on which information may be stored, phone cards, and smart cards, which may store, process, and update information, among other storage media.

In the currently preferred embodiment, the giftcard is provided in a form similar to that of a conventional credit card. Accordingly, the giftcard has a generally rectangular, plastic substrate with a magnetic strip for storing information. It will be appreciated that the precise shape of and materials used for the giftcard is not critical and, in fact, any type of portable storage device may be used. For example, the giftcard may be in the form of a key chain card having storage means affixed thereto.

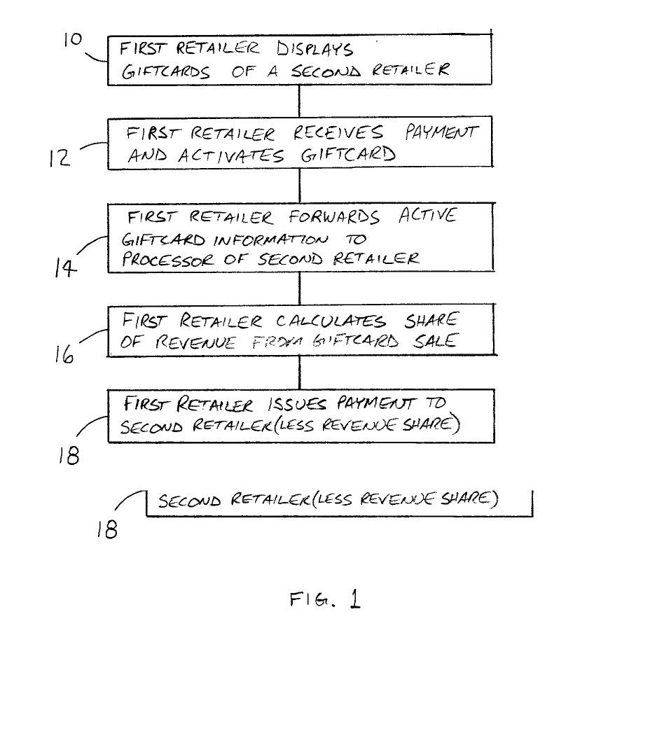

The steps for performing a giftcard sale in accordance with the teachings of the invention are shown in flowchart form at FIG. 1. Accordingly, as indicated with reference numeral 10, a first retailer displays giftcards of a second retailer. The giftcards may be enclosed in packaging to attract the attention of customers. Furthermore, the giftcards may be placed in a display fixture that may incorporate additional marketing artwork, such as signage. The giftcards are preferably positioned in a high traffic area of the store, such as near a front register.

A customer selects a giftcard and brings it to a register for purchase. The customer may use any payment means accepted by the first retailer to purchase the card. Once payment is received, the first retailer activates the giftcard 12. The register includes a card reader through which the giftcard may be swiped. Encoded on the giftcard is a card identification number. The register forwards the card identification number for the giftcard to a first retailer computer center, which updates the giftcard to active status. The computer center of the first retailer then forwards the active giftcard information to a processor of the second retailer 14. The processor may be provided by the second retailer in-house, or may be a third party card processor.

In addition to activating the giftcard, the computer center of the first retailer may also calculate a share of revenue 16 from the giftcard sale as consideration for marketing and selling the giftcard. The first retailer's share maybe a fixed fee or may be a percentage of the dollar value of the giftcard.

Finally, the first retailer issues payment to the second retailer as a result of the giftcard sale 18. Payment may be issued upon each giftcard sale or periodically (such as monthly) to reflect multiple giftcard sales. Furthermore, the first retailer's revenue share may be subtracted from the amount of the payment made to the second retailer. In addition to the payment, the first retailer may provide detailed reports to the second retailer indicating the number of giftcards sold at specific value amounts, the total number of giftcards sold, and other sales information.

In the preferred embodiment, the giftcard may have a credit value, such as $10, $15, and $25. The credit value may be prominently displayed on the giftcard and associated packaging. The card processor may pre-assign credit values according to card identification number, so that during giftcard activation, the appropriate credit value is reflected at the card processor. As a result, a customer may simply select a giftcard having a desired credit value and proceed to the register. During activation, the giftcard is swiped through the card reader and a credit value corresponding to the desired amount is automatically activated.

In the alternative, the credit value may be assigned as the giftcard is being purchased. In this alternative, rather than pre-assigning a credit value to an inactive card, the credit value is entered at the register before or after the giftcard is swiped through the card reader 16. The first retailer employee may enter any desired value to the giftcard, and the manually-entered credit value is forwarded to the processor during activation.

In an additional embodiment, the giftcard is provided in the form of a smart card. Unlike the magnetic storage strips used in the credit card style giftcards, the smart card giftcards are embedded with a microprocessor and memory. As a result, information such as credit values may be stored and adjusted directly on the card. In the smart card embodiment, a smart card reader is used to store the desired credit value on the card when it is purchased.

It will further be appreciated that while the above embodiment discloses cards usable at a single second retailer, the method may be used to sell giftcards of multiple second (or outside) retailers. In this embodiment, a set of giftcards is displayed for each outside retailer. The first retailer computer center may be programmed so that the card identification number directs the information to the appropriate processor, if more than one processor is used by the various outside retailers.

In accordance with additional aspects of the present invention, the first retailer may sell a single, multi-store giftcard that may be used at a variety of outside retailers. In this embodiment, a consortium of outside retailers may be formed that will accept the multi-store giftcard as payment for merchandise. Similar to the previous embodiments, the first retailer displays the multi-store giftcards at one of its store locations. Any display fixtures and marketing artwork, as well as the giftcards themselves, may be clearly marked to indicate the participating outside retailers at which the giftcard may be used. The first retailer receives payment for and activates the giftcard, forwarding active card information to a processor used by the multiple retailer consortium. The first retailer may then calculate a revenue share from the sale of the giftcard, and issue payment to the multiple retailer consortium.

From the foregoing, it will be appreciated that a new and improved method of selling giftcards is provided. While displayed for sale in a first retailer, the giftcards may be redeemed at a second retailer. As a result, the customer need not travel to a store location of the second retailer to purchase the giftcard. This is particularly advantageous when the second retailer is a local or regional retailer that may not have store locations near the customer.

Although certain apparatus constructed in accordance with the teachings of the invention have been described herein, the scope of coverage of this patent is not limited thereto. On the contrary, this patent covers all embodiments of the teachings of the invention clearly falling within the scope of the appended claims either literally or under the doctrine of equivalents.

What is claimed is:

1. A method for selling a giftcard at a store location of a first retailer for use at a second retailer, the method comprising:
displaying giftcards in the store location of the first retailer;
activating a giftcard upon receipt of a purchase amount from a customer;
forwarding active giftcard information to a processor associated with the second retailer; and
transferring proceeds from the first retailer to the second retailer, the proceeds including at least a portion of the purchase amount.

2. The method of claim 1, further comprising calculating a revenue share of the purchase amount for the first retailer, in which the proceeds are equal to the purchase amount less the revenue share.

3. The method of claim 1, in which the giftcard has a preset credit value.

4. The method of claim 1, in which multiple sets of giftcards are displayed at the first retailer, each set of giftcards being redeemable at a different second retailer.

5. The method of claim 1, in which the processor is provided by the second retailer.

6. The method of claim 1, in which the processor is provided by a third party associated with the second retailer.

7. A method for selling a giftcard at a store location of a first retailer for use at a plurality of second retailers, the method comprising:
displaying giftcards in the store location of the first retailer;
activating a giftcard upon receipt of a purchase amount from a customer;
forwarding active giftcard information to a processor associated with the plurality of second retailers; and
transferring proceeds from the first retailer to the plurality of second retailers, the proceeds including at least a portion of the purchase amount.

8. The method of claim 7, further comprising calculating a revenue share of the purchase amount for the first retailer, in which the proceeds are equal to the purchase amount less the revenue share.

9. The method of claim 7, in which the giftcard has a preset credit value.

10. The method of claim 7, in which the plurality of second retailers comprise an outside retailers consortium, and in which the processor is provided by the outside retailers consortium.

11. The method of claim 7, in which the plurality of second retailers comprises an outside retailers consortium, and in which the processor is provided by a third party associated with the outside retailers retailer.
